(19) United States
(12) Patent Application Publication
(10) Pub. No.: US 2012/0200916 A1
(43) Pub. Date: Aug. 9, 2012

(54) Multi-Stereoscopic Viewing Apparatus

(75) Inventor: Brad Bent-Gourley, Las Vegas, NV (US)

(73) Assignee: MAGNETIC MEDIA HOLDINGS INC., New York, NY (US)

(21) Appl. No.: 13/303,817

(22) Filed: Nov. 23, 2011

Related U.S. Application Data
(63) Continuation of application No. 12/182,869, filed on Jul. 30, 2008, now abandoned.
(60) Provisional application No. 60/935,178, filed on Jul. 30, 2007.

(51) Int. Cl. G02B 27/22

(52) U.S. Cl. 359/463

(57) ABSTRACT

A method for creating a three-dimensional multi-stereoscopic viewing apparatus includes determining characteristics of an electronically illuminating color matrix panel display having first a pixel arrangement. The method also includes determining a specification for a lenticular lens configured to convert the first pixel arrangement to a second pixel arrangement and placing the lenticular lens on the display panel. The specification for the lenticular lens is determined by calculating a viewing distance from a refraction index, a width of the display panel, and an average distance between human eyes. Determining the specification for the lenticular lens also includes determining a viewing angle that maximizes viewing characteristics and determining characteristics of the lenticular lens.

### CROSS-REFERENCE TO RELATED APPLICATION(S)

This application claims the benefit of priority of U.S. Provisional Patent Application 60/935,178, filed on Jul. 30, 2007, the contents of which are incorporated by reference in its entirety.

### FIELD OF INVENTION

The present invention is directed to a three-dimensional (“3D”) multi-stereoscopic viewing apparatus and a method of manufacturing the same.

### BACKGROUND

There are several different types of stereoscopic displays. Some stereoscopic displays require the use of special glasses to view the 3D image. Other stereoscopic displays can be viewed without the need for special 3D glasses, such as multi-stereoscopic displays, but typically have limitations, such as brightness, reflectivity, color balance, and resolution issues.

Another technology available is comprised of a lenticular lens overlay apparatus. Prior art lenticular lens overlays can produce a 3D image viewable in dynamic public traffic areas, but also result in poor image quality, cloudy imaging, ghosting effects, high cost, and poor imaging and media distribution concepts.

### SUMMARY

The details of one or more implementations of the invention are set forth in the accompanying drawings and the description below.

In one aspect, a method for creating a three-dimensional multi-stereoscopic viewing apparatus includes determining characteristics of an electronically illuminating color matrix panel (such as LCD, LED, Plasma, OLED) having first a pixel arrangement. The method also includes determining a specification for a lenticular lens configured to convert the first pixel arrangement to a second pixel arrangement by placing the lenticular lens on the display panel.

In a further aspect, the specification for the lenticular lens can be determined by calculating a viewing distance from a refraction index, a width of the display panel, and an average distance between human eyes. Determining the specification for the lenticular lens can also include determining a viewing angle that maximizes viewing characteristics and determining viewed characteristics of the lenticular lens.

In yet another aspect, a method of creating a multi-stereoscopic image is provided. The method comprises using a lenticular lens to convert a first pixel arrangement associated with a display panel to a second pixel arrangement. The first pixel arrangement can include at least three horizontally adjacent pixels and the second pixel arrangement can include at least nine sub-pixels arranged in three vertical groups of sub-pixels.

In still a further aspect, a three-dimensional multi-stereoscopic viewing apparatus is provided comprising a display panel having a first pixel arrangement and a lenticular lens configure to be used with the display panel, wherein the lenticular lens is configured to convert the first pixel arrangement to create a second pixel arrangement. The lenticular lens can have additional characteristics including: an applied lens angle determined from pixel measurements; a lens pitch determined from pixel measurements; and a lens thickness.

The aforementioned aspects and other aspects can additionally include one or more of the following features: a first pixel arrangement comprising at least three horizontally adjacent pixels; a second pixel arrangement comprising at least three vertical groups of sub-pixels, the vertical groups of sub-pixels can further comprise at least three vertically adjacent sub-pixels; the lenticular lens can be placed at a predetermined angle with respect to the display panel; the predetermined angle can be the applied lens angle; the lenticular lens can rotate the first pixel arrangement by 90 degrees of an axis of the lens; the display panel can be a Liquid Crystal Display panel; the display panel can have characteristics including a pixel distance measurement; the lenticular lens can be a plano-convex lenticular lens; and the characteristics of the lenticular lens can comprise calculating an applied lens angle from pixel measurements, calculating a lens pitch form pixel measurements, and calculating lens thickness.

Aspects of the invention can include one or more of the following advantages: multi-stereoscopic viewing without the use of special eyewear; limited loss of display panel light output due to lens clarity; true stereoscopic views by representing full occlusion, real world eye view parallax, disparity, and shadow; true stereoscopic views maintained in actual multiple images; improved image clarity; and higher per view sub-pixel count in images.

Other features and advantages will be apparent from the following description, the accompanying drawings and the claims.

### BRIEF DESCRIPTION OF THE DRAWINGS

FIG. 1 is an illustration of a portion of an example LCD panel.

FIG. 2 is an illustration of a lenticular lens overlaid on a portion of an LCD panel and the corresponding image view matrices.

FIG. 3 is an example horizontal overview of a pixel path through the lenticular lens to an eye-view point.

FIG. 3A is an example horizontal overview of a pixel path through the lenticular lens to an eye-view point in the repeat zones 9 through 1.

FIG. 4 is an example illustration of a single image view as it appears to an observer through a lens.

FIG. 5 is an example digital bitmap image of the corresponding image view from FIG. 4.

FIG. 6a is an example of an image view's illuminated pixels and its corresponding digital image bitmap.

FIG. 6b is an example of a second image view's illuminated pixels and its corresponding digital image bitmap.

FIG. 6c is an example of a third image view's illuminated pixels and its corresponding digital image bitmap.

FIG. 7 shows a one-eye view of an image view shown discretely through each lens, where the sub-pixels are rotated by 90% of the axis of the lens.

FIG. 8 is an example illustration of three vertically adjacent pixels.

FIG. 9 is an example illustration of eight horizontally adjacent sub-pixels.

FIG. 10 is an example of a plano-convex lens.

FIG. 11 is an example portion of a lenticular lens sheet.

### DETAILED DESCRIPTION

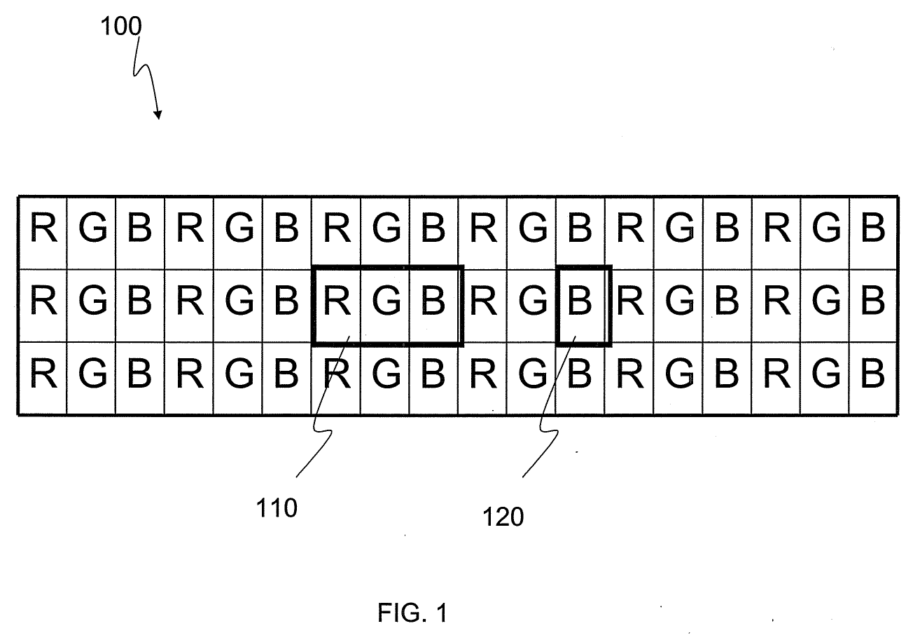

FIG. 1 shows a portion of an example color LCD panel 100. The LCD panel 100 comprises many individual pixels, horizontally arranged, in which each pixel 110 consists of sub-pixels 120. The sub-pixels 120 can be different colors, for example three different colors. Each adjacent sub-pixel 120 can represent a color such as red, green, or blue. A pixel 110 will be displayed white when the red, green, and blue sub-pixels 120 are equally illuminated. The pixels 110 can be illuminated in either a matrix or interlaced fashion for the 3D display of the disclosed embodiments by manipulating the digital bitmap image to match the overlaid lenticular lens.

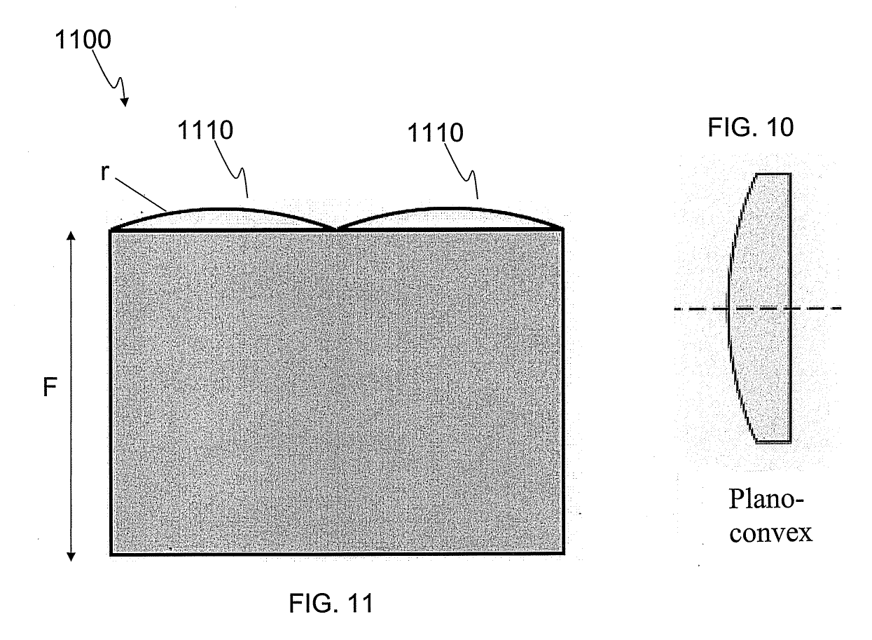

A lenticular lens can be a repetition of microscopic aspherical lenses (i.e., lenticules). The microscopic aspherical lenses can be similar to magnifying glasses. In one embodiment, the lenticular lens comprises a plurality of plano-convex lenses. FIG. 10 illustrates an example plano-convex lens. FIG. 11 shows an example lenticular lens 1100 with two plano-convex lenticules 1110. Each plano-convex lenticule 1110 has a radius of curvature “r” and a focal distance “F”. The focal distance “F” is also referred to as the total lens thickness.

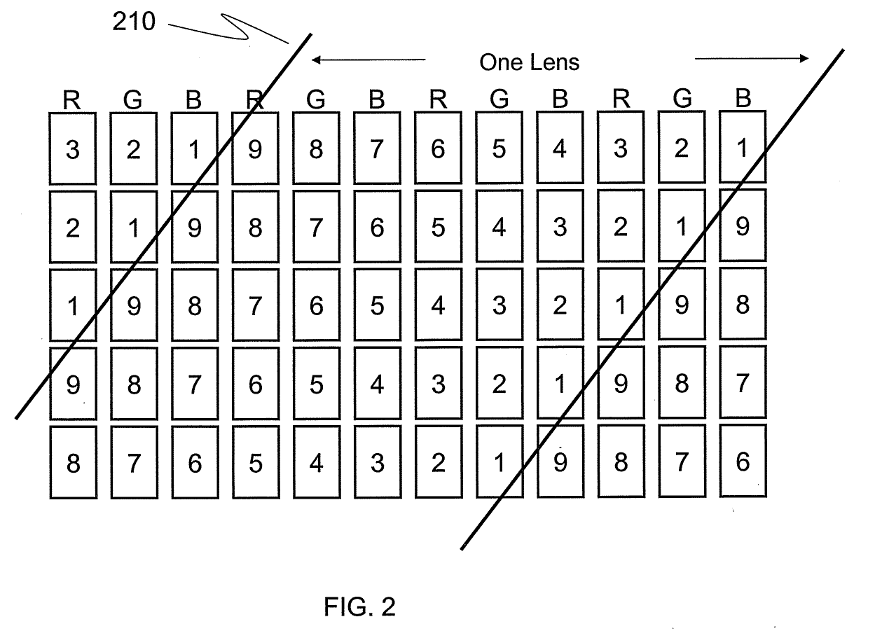

The lenticular lens can be placed over the sub-pixels or pixels in such a fashion that at a distance, the pixels are combined in the viewer's eyes to form discrete left and right eye-views that can be perceived as three-dimensional. FIG. 2 illustrates a lenticular lens 210 placed at an angle (i.e. an applied lens angle), slanted to the right, that is overlaid on top of the pixels of a typical LCD.

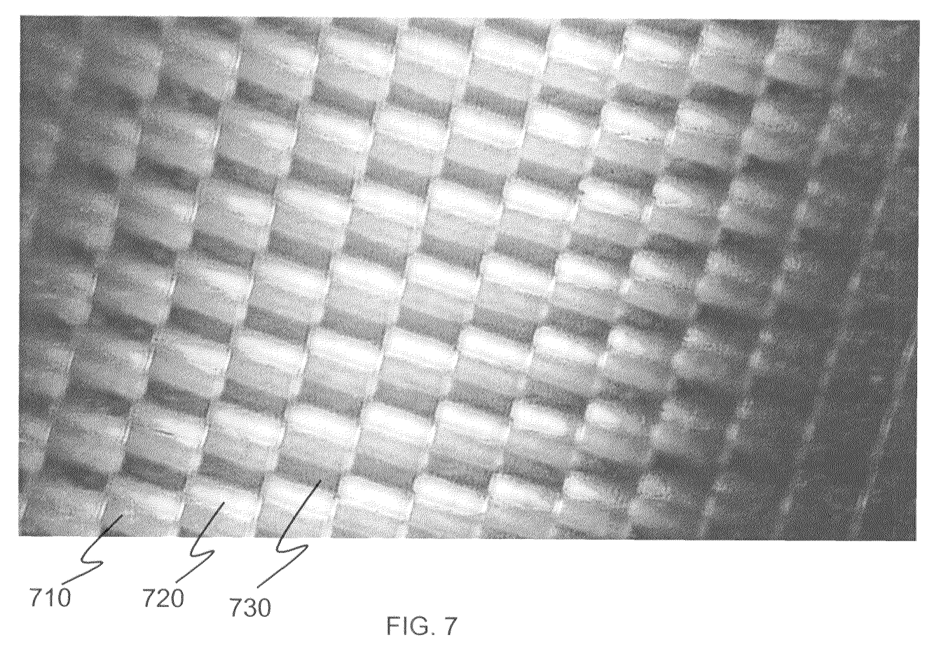

In one aspect of the present disclosure, three pixels are combined per lenticule, which equals nine sub-pixels horizontally, or nine discrete image views. Without a lens applied, the LCD panel typically uses three equally illuminated sub-pixels (one red, one green, and one blue), arranged horizontally, to form a single white pixel. To create a single white pixel with a lenticular lens applied, the effects of the lens' aspherical shape are compensated for. The lens is placed at an angle to project a red, green, and blue pixel diagonally vertical. The pixels are rotated 90 degrees from the lenticule axis. The amount of rotation depends on the radius of the lenticule and the lens material's index of refraction. FIG. 7 shows an exemplary embodiment wherein the sub-pixels are rotated by 90 degrees of the axis of the lens. Each pixel includes a red 710, green 720, and blue 730 sub-pixel. Therefore, three sub-pixels (one each of red, green, and blue), are illuminated vertically rather than horizontally to create the white pixel. Therefore, when the images are combined to be presented on the display, the images must be combined at a sub-pixel level.

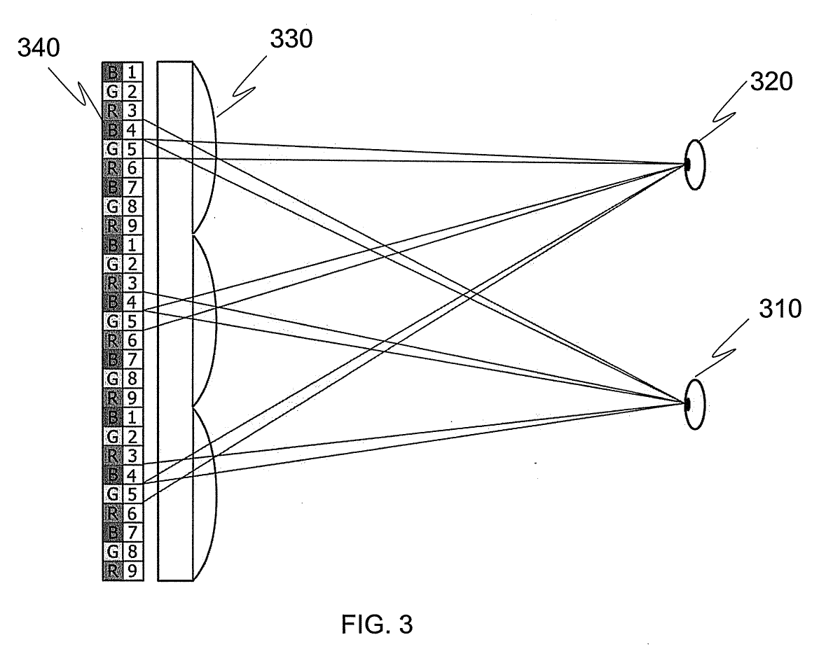

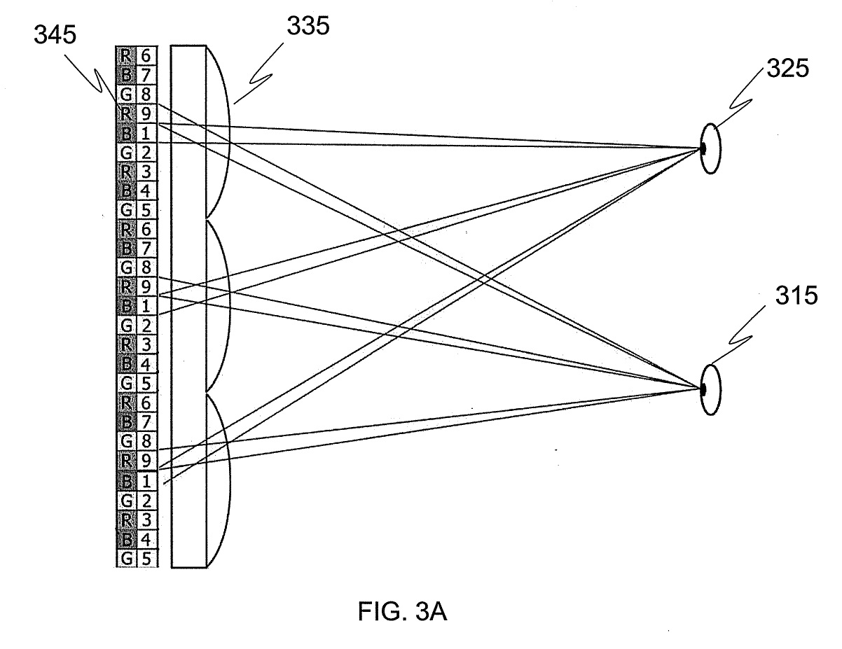

FIG. 3 illustrates a horizontal depiction of the pixel path from the LCD panel 340 through the lenticules 330 to an observer's left eye 310 and right eye 320 view points. The right eye 320 sees image view 5 from the LCD panel 340 (i.e., image view 5), while the left eye 310 sees image view 4 from the LCD panel 340 (i.e., image view 4).

FIG. 3A illustrates a horizontal depiction of the pixel path from the LCD panel 345 through the lenticules 335 to an observer's left eye 315 and right eye 325 view points. Adjacent zones such as adjacent zone 4 and adjacent zone 5 (as shown in FIG. 3), combine to create a stereoscopic view. When the viewer is in the zone where image view 9 combines with image view 1 (as show in FIG. 3A), this is known as the repeat zone. The repeat zone is also known as the reverse or transitional zone. The imaged viewed when image view 9 and image view 1 are combined is generally a pseudo stereoscopic or reversed image, and typically not a desirable image. The right eye 325 sees the image view 1 from the LCD panel 345, while the left eye 315 sees image view 9 from the LCD panel 345. The stereoscopic image is reversed because the image view zones 1-9 move left to right relative to the viewpoint. This is generally known as a pseudo stereoscopic or reversed image.

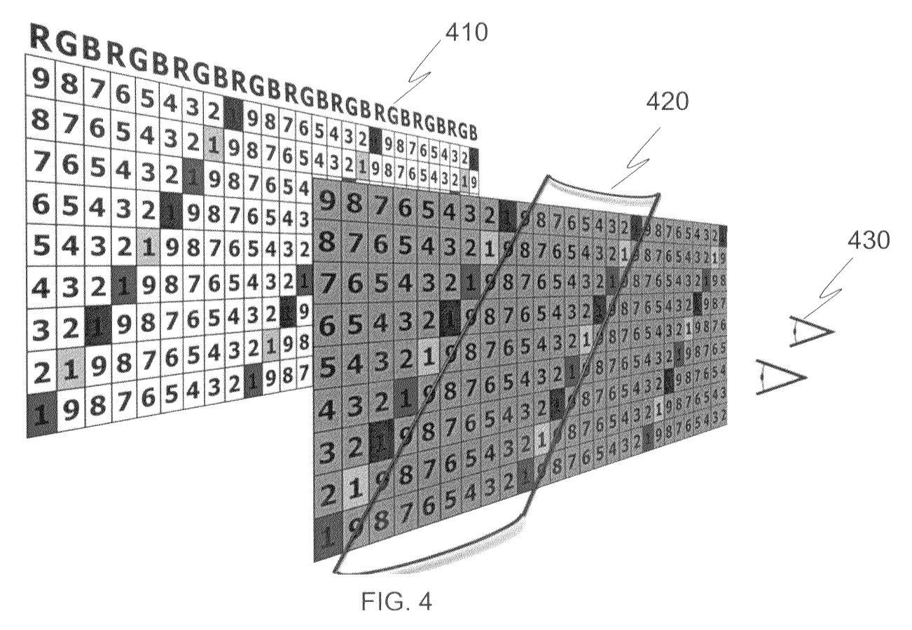

FIG. 4 is an example illustration of image view “1” as it appears to an observer viewing image view “1” through a lens. The pixel structure of the LCD panel 410 shows the image view 1 illuminated white. Image view 2 through image view 9 are dark. A magnified view of a single lenticule 420 overlaid over nine sub-pixels demonstrates the pixel structure as seen through one lenticule, from the observer's 430 viewpoint.

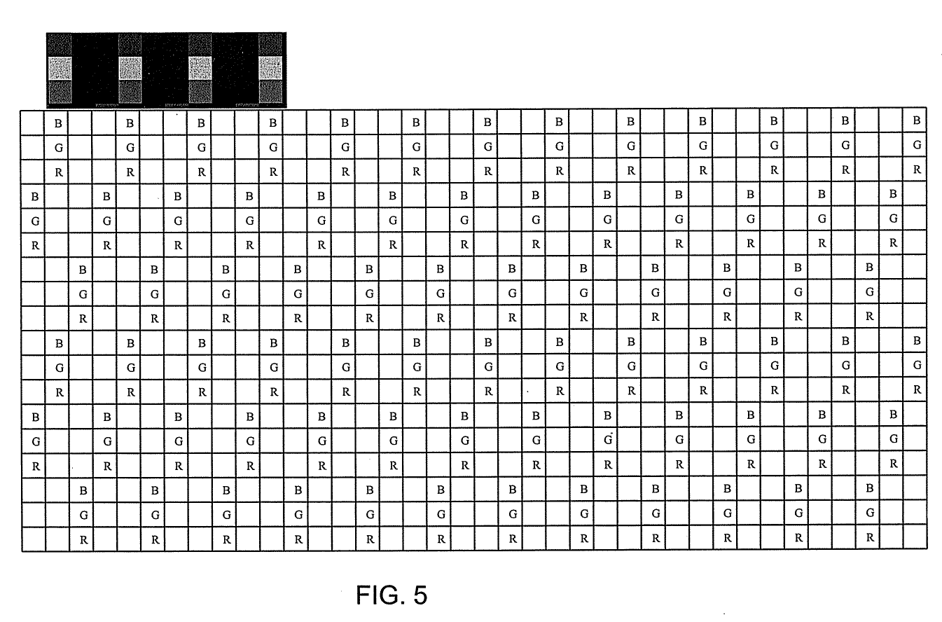

FIG. 5 is an example digital bitmap image of a corresponding image view one. FIG. 5 illustrates the digital bitmap image after it is combined and displayed from a digital playback device (e.g., a personal computer) to create the white image view 1 shown in FIG. 4.

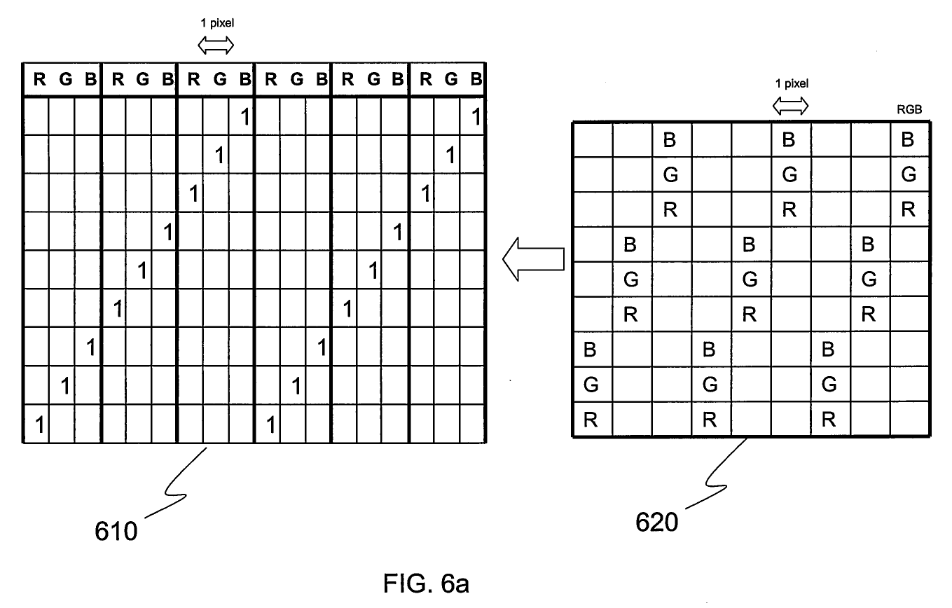

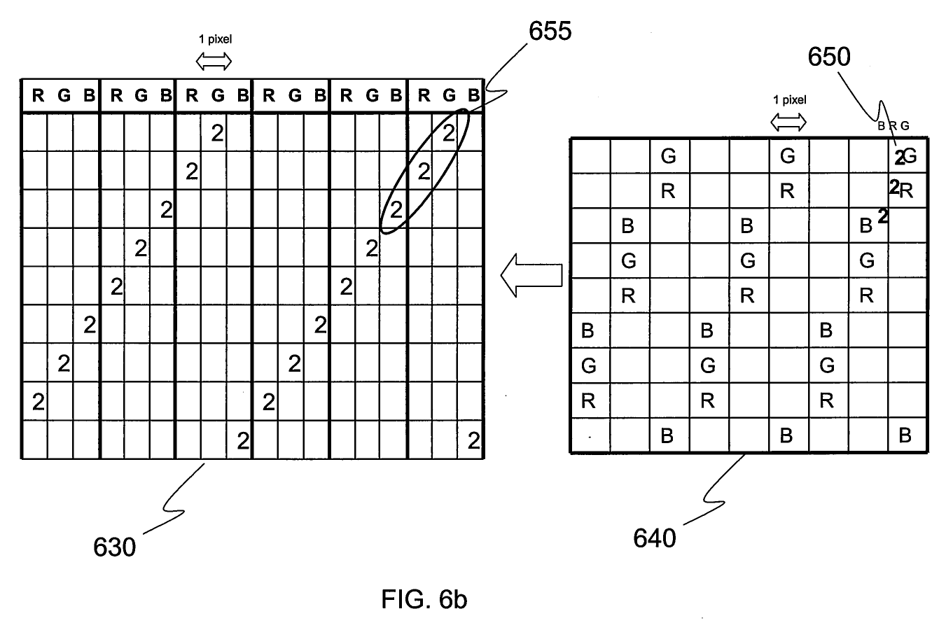

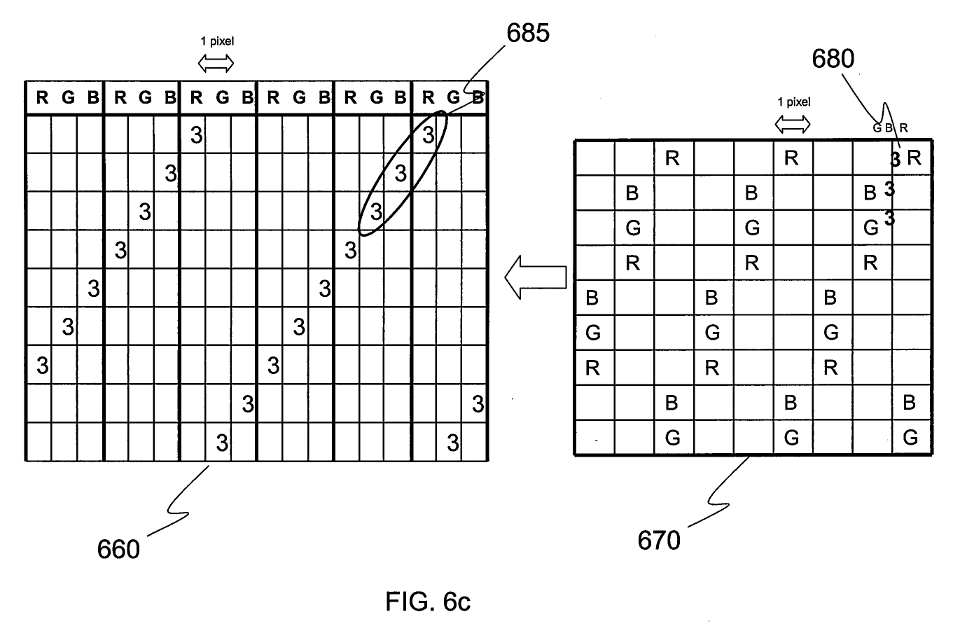

FIGS. 6a, 6b, and 6c show the first through third image views 610, 630, and 660 respectively, and the corresponding digital bitmap images 620, 640, and 670 respectively. As each digital bitmap image is advanced to the next image view (1, 2, 3 etc), the blue, red, and green sub-pixels on the image view shift upwards to illuminate the next horizontally left pixels. This causes these pixels to appear in the next lens eye view area. The pixels appear to move horizontally towards the right side of the panel. In order to obtain the best viewing image however, the sub-pixels are grouped together in an arrangement that minimizes the spacing between sub-pixels. For example, in the second image view 630, the circled sub-pixels 655 correspond to (denoted with an adjacent number 2) 650 on the digital bitmap image 640. Similarly, for the third image view 660, the circled sub-pixels 685 correspond to (denoted with an adjacent number 3) 680 on the digital bitmap image 670. When deriving the remaining fourth through ninth bitmap images, one would group the sub-pixels in a likewise manner. Summing the first through ninth images together, the pixel pattern would result in the entire screen of the LCD being fully illuminated white. In an embodiment, all images are combined using an additive screen layer combining mode in a digital composite. A digital 24 bit color composite scheme can be used. The 24 bit color composite scheme assumes the original image is black and the final color is equal to the sum of the color amount added to black value. The 24 bit color composite scheme can provide 16 million color combinations.

Various techniques can be used to create the multiple images to be simultaneously displayed. In one embodiment, a series of pictures of an object or objects can be taken from different positions which correspond to the different views that a person can see in each eye. The series of pictures can be taken from a single camera whose position is adjusted for each image or from a series of cameras that take the multiple images at the same time (thereby increasing the likelihood that the shadows across the objects will be the same and not affected by temporal differences). In other implementations, the images can be computer generated as occurs in computer video games and computer animations (CGI). For example, instead of creating a computer image of a computer generated model from a single camera point of view, a computer rendering engine can create images from multiple points of view corresponding to the views that the viewer is intended to see in each eye. Because the images are taken or generated from different points of view, adjacent images will create two complementary images which enable the viewer to see the images as three-dimensional.

The images can be taken or generated from a planar adjacent perspective or from a perspective that circles around the object(s). This allows a viewer to virtually look around the object(s) moving between the adjacent viewing areas.

LCD display panels are manufactured to different specifications according to individual manufacturer specifications. In an embodiment of the present invention, the lens design was specifically derived for a LCD of specific dimensions and type. Based on actual measurements of the pixel distance, screen width, the number of image view zones desired, and average human characteristics (e.g., eye width, comfortable viewing distance), a specification for a lenticular lens sheet can be derived, including the thickness of the lens, ideal viewing distance and viewing angle, and the assembled angle of the lens to the LCD.

In one embodiment, a desired comfortable viewing distance can be estimated by multiplying the refraction index, the average distance apart of the human eyes (i.e., interpupillary distance), and the width of the display (i.e., the horizontal width of a LCD screen). For example, a desired viewing distance of 12 feet can be established from a predetermined refraction index of 1.4, an interpupillary distance of 2.5 inches (with acceptable ranges between 2 to 3 inches, and a display width of 41.05 inches (i.e, the horizontal width of a 47 inch LCD screen). Viewing distances from 8 feet to 16.6 feet can be determined using a refraction index between 1.2 and 1.65 and an interpupillary distance between 2 to 3 inches.

A viewing angle for the lens can also be determined. In one embodiment, a lens depth/radius is 0.1353 inches provided perception of “in screen” depth and off-screen “pop” of approximately 6 inches and a side to side viewing angle of 14 degrees before reverse zones were visible. A viewing angle can be varied between 16 degrees to 6 degrees to provide in screen depth and off-screen pop values of 4 to 12 inches.

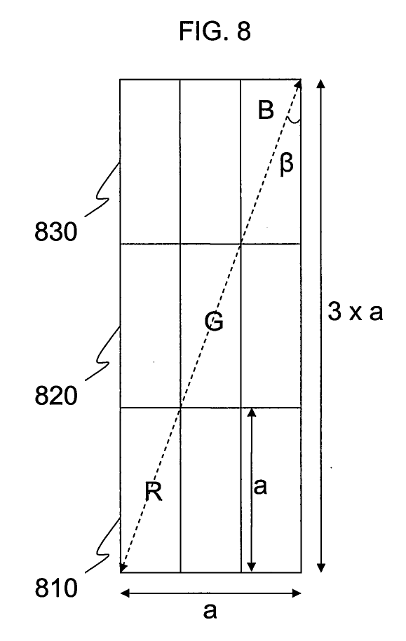

The angle that the lens can be tilted, as it is applied on the LCD panel, is known as the applied lens angle or the total lens tilt angle. In one embodiment, the applied lens angle can be determined using the measurements of a pixel. FIG. 8 shows three vertically adjacent pixels 810, 820 and 830 and each of these pixels 810, 820 and 830 have the same height as the width (e.g., height and width=a). Each pixel comprises three horizontally adjacent sub-pixels in a blue, green, red pattern and have the same physical dimensions. For example, pixel 810 comprises three sub-pixels B, G, R each having equal width and height (e.g., a/3×a). Pixels 820 and 830 also have a similar sub-pixel pattern. The applied lens angle β can be calculated using the geometry of a triangle created by the height of the three vertically adjacent pixels 810, 820 and 830 (i.e., 3×a) and the width of pixel 810 (i.e., a).

$$β = {tan}^{- 1} ( \frac{a}{3 \times a} )$$

In addition, the applied lens angle β can be determined. For example, the applied lens angle β and the physical dimensions of the pixels 810, 820 and 830 can be physically measured by using an optical microscope to measure the angle of the pixels in image view 610 of FIG. 6a with respect to the vertical center. Using the optical microscope, the height and width of pixel 810 can be measured to be 0.5415 mm and the applied lens angle then determined to be 18.43 degrees off the vertical axis leaning to the right from bottom to top.

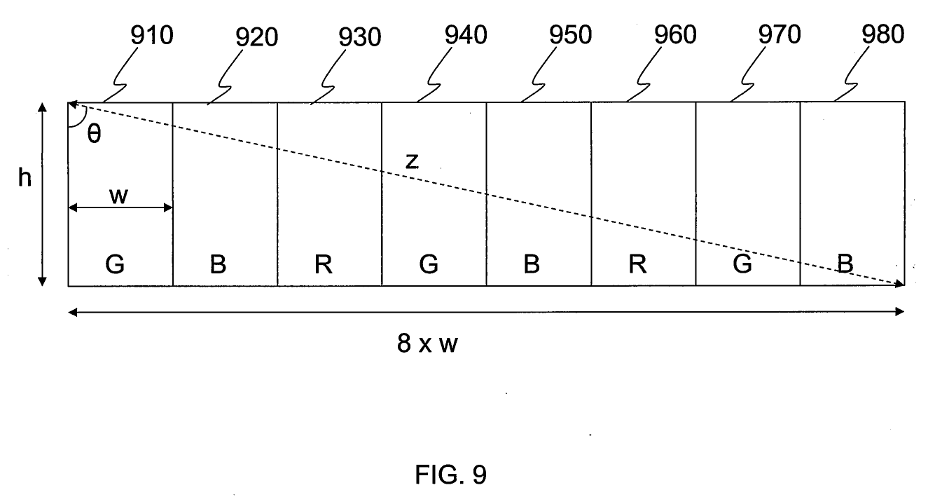

The width of each lenticule in the lenticular lens is referred to as the lens pitch. In one embodiment, the lens pitch can be determined using the dimensions of a pixel. For example, FIG. 9 shows eight horizontally adjacent sub-pixels 910, 920, 930, 940, 950, 960, 970 and 980 each having the same physical measurements. The lens pitch z can be determined by calculating the hypotenuse of the triangle formed by the height of sub-pixel 910 (e.g., h) and the width of the eight sub-pixels 910-980 (e.g., 8×w) can be calculated using the equation:

h²+(8×w)²=z².

The lens pitch z can then be used to determine the number of lenses per inch of the lenticular lens. For example, the number of lenses per inch can be determined by taking the reciprocal of the lens pitch z, assuming lens pitch z is measured in inches. If lens pitch z is not measured in inches, then lens pitch z needs to be first converted to inches before calculating the lenses per inch of the lenticular lens.

As with a standard magnifying glass, the distance of the lens from the object determines focal distance (i.e., the lens thickness). The thickness of the lenticular sheet will determine the focal distance but also correlates to the viewing angle, clarity, and sharpness of images. Depending on the type of lenticular lens (e.g., a plano-convex lenticular lens), the type of material, and the radius of the lenticules, the lens will refract or bend the light in a specific manner. The refraction of light will result in a rotated image and focus.

Determining a proper focal distance reduces the distortion of resulting image. Example types of distortion include cross talk between the view zones comprising the lenticular sheet, blurriness, moiré patterns. Also, determining the proper focal distance will help focus the left and right images at the proper viewing distance in front of the lenticular sheet to each of the viewer's eyes.

FIG. 11 illustrates a portion of an example lenticular sheet 1100. The lenticular sheet 1100 has two plano-convex lenses 1110. Each plan-convex lens 1110 has a radius of curvature=r. In one embodiment, the focal distance F can be calculated using the known lens formula, where n=the index of refraction associated with the lens material.

$$F = \frac{r}{n - 1}$$

In one example, the plano-convex lenses can have a radius of curvature r=0.1300 and the lenticular sheet is made of a composite of acrylic, polyester, polymer plastics and optical liquid bonding resins. Such composite material has a predetermined index of refraction of n=1.4. From this value, the focal distance can be determined to be 0.325 inches. The focal distance “F” includes the thickness of the lens sheet beneath the actual lenticule.

Using the above-described measurements for the lenticular lens, a fabricator is able to engrave a lenticular molding cylinder. The cylinder is placed in an ultraviolet curing apparatus, where a piece of PET (polyethylene terephthalate) material, aka Dupont Mylar® but more generically referred to as Polyester Film, is thin coated with a wet plastic composite which rolls over the cylinder as the ultraviolet light cures the composite plastic in the shape of the molding cylinder that was created from the specifications provided. The change in the temperature of the material is negligible therefore no cooling time is required. The molded lens material is then laminated with high quality optical adhesive to an acrylic polymer blended sheet, or glass in the correct thickness to match the total lens thickness specified. The lens can be stored on flat palettes and shipped as needed. In an embodiment the lens is installed on the LCD panel using metal alignment rails or rubber adhesive.

Lenses may be made according to any manufacturing technique that provides the effect of the lenticular lens described herein. Such techniques, include, but are not limited to, extruding, UV fabrication, injection molding, and etching. In an exemplary method the lens may be fabricated from polyethylene terephthalate (PET) (C10H8O4) e.g., using UV fabrication as mentioned above. This method provides a more consistent tolerance to the microscopic specification needed to obtain the optimum viewing distance (sweet spot) and maintain the consistent lens per inch tolerance keeping straight vertical lenses that minimizes any noticeable moiré patterns.

To reduce moiré of black, the LCD display is selected with a minimal gap between pixel elements and rows of pixel elements as possible.

In summary, therefore, there has been described a multi-stereoscopic display apparatus comprising means for creating a multi-stereoscopic images utilizing a lenticular lens overlaid on top of a electronically illuminating color matrix panel (such as LCD, LED, Plasma, OLED) consisting of pixels arranged in a horizontal fashion. The lenticular lens is further fabricated for the display based on certain characteristics of the display and the desired viewing experience.

While certain configurations of the image views for the multi-stereoscopic display apparatus have been illustrated for the purposes of presenting the basic apparatus of the present invention, one of ordinary skill in the art will appreciate that other variations are possible which would still fall within the scope of the appended claims. One can envision varying the number of discrete image views possible by combining different numbers of pixels per lens. Also, the sub-pixels of the bitmap image could possibly be grouped in a different fashion vertically to obtain an alternate image quality. The angle of the lenticular lens could also be varied so as to change the optimal selection of discrete image views and sub-pixels.

Further, the above-described lenticular lens may be utilized on electronically illuminating color matrix panel displays other than LCD panels such as LED, Plasma, OLED, & LCOS (Liquid Crystal on Silicon). Moreover, the amount of black space between pixels, or pixel closeness proximity, preferably is as small as possible. The series of images described herein that are combined to create the various views may be combined either in non-real-time or in real-time. For example, a series of images can be captured and combined prior to utilizing the display. This non-real-time processing can be used when the images to be displayed are static. Alternatively, the display may include a specialized video card that draws the various images into their own corresponding display memories and then the contents of the display memories are combined in the proper order as they are needed in order to achieve the various views. Such a real-time system may be used when the images change due to dynamic interaction (e.g., due to interaction with a user).

The potential fields of use include, but are not limited to, utilizing the apparatus for use in entertainment mediums such as 3D gaming (including portable gaming devices), 3D video jockey capability for use in nightclubs, concerts, sporting and other special events, or other entertainment means such as iPods, 3D karaoke systems, 3D motion rides at amusement parks or for a 3D monitor for personal computer gaming. The 3D viewing apparatus can also be placed inside gaming devices such as slot machines or upright video games.

The 3D multi-stereoscopic viewing apparatus can also be used to enhance digital signage. For example, casinos commonly use digital signage throughout the casino including areas such as the table game areas, slot machine areas and check in areas. The digital signs are used to gain the attention of potential garners and entice them to play the slot machines or the table games such as roulette or craps. The digital signs can also be used to advertise other entertainment or services offered by the casino. Another example is the digital signs used at entertainment venues. The venue can use digital signs to market different events taking place at the venue such as a movie, concert or sporting event. Digital signs can also be used to market theme parks. A third example is the digital signs used in stores or retail environments. These signs could be used at the check out counter or at the end of aisles to highlight featured items or sales.

Other commercial uses could be applied in advertising, such as for 3D Digital signage billboards of various dimensions, 3D displays of corporate artwork, and interactive 3D displays for directories such as can be found in buildings, malls, department stores, etc. Also envisioned are uses for communication and navigation activities such as for use in 3D live video conferencing, for displays on cellular phones, in Global Positioning Systems (GPS) devices, in 3D displays such as an odometer, tachometer, etc., found in automotive, aerospace, and other transportation vehicles, and for use in Bluetooth enabled 3D technology. Additionally, the current invention could be employed in several professional fields such as in: 3D medical imaging (giving a 3D multi-stereoscopic view of bones, ligaments, tendons, etc.); 3D architecture (showing 3D multi-stereoscopic renderings of original computer-aided design (CAD) drawings); 3D real estate offering virtual tours through available properties, 3D customer service and sales functions (such as at an airport check-in counter or a 3D salesman at auto dealerships); and in military, government, security, (TSA) and civilian 3D simulation displays for flight training and mission planning (including space flight).

In some configurations, it is likely that at least a portion of the display images will have to be generated in real-time. For example, in the case of a display-based casino gaming table or slot machine, the player's current balance is unlikely to be pre-computed, so at least that portion of the image may be dynamically generated.

Other variations not expressly addressed will be apparent to one of ordinary skill in the art which would still fall within the scope of the appended claims. Although embodiments have been described using a LCD panel of specific dimensions, it is to be understood that the 3D viewing apparatus is not to be limited to the disclosed embodiment, but on the contrary, is intended to cover various modifications and equivalent arrangements included within the spirit and scope of the appended claims.

1-18. (canceled)

19. A three-dimensional viewing apparatus comprising:
a display panel with pixels arranged into horizontal rows and vertical columns; and
a lenticular lens of a predetermined refraction index through which a user views the display panel, the lenticular lens arranged into multiple columns of plano-convex lenticules, each lenticule having a selected radius and a focal distance that is calculated from the refraction index and the selected radius;
wherein the lenticular lens is applied to the display panel such that the columns of lenticules deviate from the vertical by a predetermined applied lens angle; and
wherein each column of lenticules has a width such that when the lenticular lens is applied at the predetermined applied lens angle, each column of lenticules will span three columns of pixels of the display panel.

20. The three-dimensional viewing apparatus of claim 19, wherein the display panel is an electronically illuminating color matrix panel.

21. The three-dimensional viewing apparatus of claim 20, wherein the display panel is selected from the group consisting of LCD, LED, plasma, OLED, and liquid crystal on silicon.

22. The three-dimensional viewing apparatus of claim 19, wherein the lenticular lens comprises polyester film laminated with optical adhesive to either glass or an acrylic polymer blended sheet.

23. The three-dimensional viewing apparatus of claim 19, wherein the lenticular lens comprises polyester film laminated with optical adhesive to a glass sheet.

24. The three-dimensional viewing apparatus of claim 19, wherein the lenticular lens is applied to the display panel using metal alignment rails.

25. The three-dimensional viewing apparatus of claim 19, wherein the lenticular lens is applied to the display panel using rubber adhesive.

26. The three-dimensional viewing apparatus of claim 19, in which the width of the display panel is calculated from the desired viewing distance.

27. The three-dimensional viewing apparatus of claim 19, wherein each pixel is comprised of three horizontally arranged subpixels, so that each column of lenticules spans nine columns of subpixels, providing nine discrete image views.

28. A method for creating a three-dimensional viewing apparatus comprising:
selecting a display panel with pixels arranged into horizontal rows and vertical columns;
designing a lenticular lens of a predetermined refraction index through which a user views the display panel, comprising arranging the lenticular lens into multiple columns of plano-convex lenticules of a predetermined width, each lenticule having a selected radius and a focal distance that is calculated from the refraction index and the selected radius; and
applying the lenticular lens to the display panel such that the columns of lenticules deviate from the vertical by a predetermined applied lens angle;
wherein the predetermined width of each column of lenticules is such that when the lenticular lens is applied to the display panel at the predetermined applied lens angle, each column of lenticules spans three columns of pixels of the display panel.

29. The method of claim 28, wherein the display panel is an electronically illuminating color matrix panel.

30. The method of claim 29, wherein the display panel is selected from the group consisting of LCD, LED, plasma, OLED, and liquid crystal on silicon.

31. The method of claim 28, wherein the lenticular lens comprises polyester film laminated with optical adhesive to either glass or an acrylic polymer blended sheet.

32. The method of claim 28, wherein the lenticular lens comprises polyester film laminated with optical adhesive to a glass sheet.

33. The method of claim 28, wherein the lenticular lens is applied to the display panel using metal alignment rails.

34. The method of claim 28, wherein the lenticular lens is applied to the display panel using rubber adhesive.

35. The method of claim 28, in which the width of the display panel is calculated from the desired viewing distance.

36. The method of claim 28, wherein each pixel is comprised of three horizontally arranged subpixels, so that each column of lenticules spans nine columns of subpixels, providing nine discrete image views.
